(19) United States
(12) Patent Application Publication
(10) Pub. No.: US 2026/0030228 A1
(43) Pub. Date: Jan. 29, 2026

(54) Efficient Core Reindexing

(71) Applicant: Oracle International Corporation, Redwood Shores, CA (US)

(72) Inventors: Shushuai Zhu, Nashua, NH (US); Nagarajan Muthupandian, Thane (IN); Jerry Paul Russell, Seattle, WA (US); Raghvendra Sahu, Lucknow (IN)

(73) Assignee: Oracle International Corporation, Redwood Shores, CA (US)

(21) Appl. No.: 19/054,168

(22) Filed: Feb. 14, 2025

Related U.S. Application Data
(60) Provisional application No. 63/676,771, filed on Jul. 29, 2024.

(51) Int. Cl. G06F 16/951

(52) U.S. Cl. CPC G06F 16/2272

(57) ABSTRACT

Techniques are disclosed for performing reindexing operations for indexes associated with search engine cores. A system determines that a core is associated with a core index that is a candidate for reindexing. The core is configured to execute an instance of a core index that includes a mapping of terms to metadata. Responsive to determining that the core index is a candidate for reindexing, the system performs a reindexing operation at least by (a) detecting workload characteristics associated with the core index, (b) based at least in part on the workload characteristics, selecting a configuration for the reindexing operation, and (c) initiating the reindexing operation using the selected configuration.

### INCORPORATION BY REFERENCE; DISCLAIMER

The following application is hereby incorporated by reference: Application 63/676,771, filed Jul. 29, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to indexing technology. In particular, the present disclosure relates to the performance of reindexing operations for a search platform.

### BACKGROUND

Search engines are systems designed to retrieve relevant information from datasets based on user queries. Search engines rely on structured data, known as indexes, to improve search performance. An index is a data structure that organizes information in a way that facilitates retrieval operations as an alternative to requiring that the search engine scan the entire dataset in response to each search query. Search engines use a process called “indexing” to create and manage these indexes, to support query processing and relevance ranking. Indexing uses algorithms and storage mechanisms to process, analyze, and store data in a format that supports search and retrieval operations. A search engine may be part of a search platform, which encompasses a broader set of tools and services designed to facilitate the indexing, retrieval, and analysis of data. While the search engine focuses specifically on querying and ranking results, the search platform integrates additional capabilities, such as data ingestion, preprocessing, scalability, and user interface components. It often provides application programming interfaces (APIs) for customization, advanced analytics, and features such as faceted navigation, real-time updates, and multi-language support, making it a comprehensive solution for building tailored search-driven applications. The architecture of search engines may incorporate distributed components that help with scalability and fault tolerance in handling large-scale data.

Search engine cores are logical units within the system that are responsible for maintaining and managing independent indexes. Cores are logical units that encapsulate individual indexes along with their associated schemas and configurations, allowing for modular and independent management of data subsets. A core includes both the searchable index and the configuration settings that govern its behavior, such as field definitions, query parsing rules, and runtime parameters. These cores operate independently, allowing multiple datasets or configurations to coexist within a single search engine instance. This modular approach supports flexibility in managing data for distinct use cases, such as multi-tenant systems or domain-specific searches. Cores communicate with other components through defined APIs to process and return search results.

Periodic reindexing is required to maintain the accuracy and relevance of the indexed data. As data in the underlying source evolves due to updates, additions, or deletions, the corresponding indexes are refreshed to reflect these changes. Over time, schema updates, software upgrades, and/or performance considerations may necessitate reindexing, a process by which the existing index is reconstructed to reflect updated configurations and/or to ensure compatibility with the system's current capabilities. Reindexing involves recreating or updating the index based on the current state of the data source. These processes help the search engine to deliver results that are aligned with the most current dataset while maintaining performance and reliability.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a search engine core in accordance with one or more embodiments;

FIG. 2 illustrates a system in accordance with one or more embodiments;

FIG. 3 illustrates an example set of operations for performing a reindexing operation in accordance with one or more embodiments;

FIG. 4A illustrates an example set of core indexes at the reindex planning stage in accordance with one or more embodiments;

FIG. 4B illustrates an example set of core indexes at the reindexing stage in accordance with one or more embodiments;

FIG. 4C illustrates an example set of core indexes after the reindexing stage in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SEARCH ENGINE CORE MANAGEMENT ARCHITECTURE
3. PERFORMING A REINDEXING OPERATION
4. EXAMPLE EMBODIMENT
5. PRACTICAL APPLICATIONS, ADVANTAGES & IMPROVEMENTS
6. COMPUTER NETWORKS AND CLOUD NETWORKS
7. HARDWARE OVERVIEW
8. MISCELLANEOUS; EXTENSIONS

### 1. General Overview

One or more embodiments determine that a core is associated with an index that would benefit from a reindexing operation and perform efficient core reindexing based on workload characteristics associated with the operating environment. For example, an index may be incompatible with aspects of the system because of a recent upgrade, in which case a reindexing operation helps to ensure that the index is compatible with the upgraded search engine or search platform version. To determine that a core is associated with an index that would benefit from a reindexing operation, one or more embodiments analyze metadata associated with the core index. The metadata may include a version number or other relevant information used to identify the need for a reindexing operation. One or more embodiments detect a set of workload characteristics associated with the operating environment and select a configuration for a reindexing operation based on the workload characteristics. Once the configuration is selected, the reindexing operation is executed.

One or more embodiments described in this Specification and/or recited in the claims may not be included in this General Overview section.

### 2. Search Engine Core Management Architecture

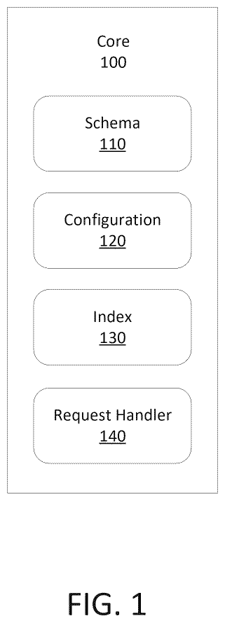

FIG. 1 illustrates a search engine core 100 in accordance with one or more embodiments. Search engine core 100 includes a schema 110, a configuration 120, an index 130, and a request handler 140.

In an embodiment, schema 110 provides a structured framework for defining fields and their properties within a core. Schema 110 specifies field names, data types, and attributes that determine how data is indexed, stored, and retrieved. Attributes may indicate if fields are tokenized for text analysis, stored for retrieval in responses, and/or excluded from search operations. Schema 110 may also include dynamic field definitions that automatically apply rules to fields matching specific patterns, allowing for flexible handling of data with varying structures.

In an embodiment, schema 110 interacts with configuration 120 by aligning the defined fields with query processing rules and indexing behaviors. Configuration 120 may reference schema 110 to specify field-level operations, such as analyzers or tokenizers, that transform incoming data or queries. Schema 110 interacts with index 130 by dictating how data is structured during indexing, including the use of term dictionaries, postings lists, and field-specific optimizations. Schema 110 also supports request handler 140 by supporting field-specific operations, such as filtering, sorting, and faceting, during query execution.

In an embodiment, configuration 120 includes settings that define the operational parameters for core behavior. Configuration 120 may specify caching policies for query results, update handling rules for data ingestion, and threading models for concurrent operations. Configuration 120 can include definitions for request processing pipelines, including custom query parsers, filters, and transformers, that modify queries before execution. Configuration 120 supports the integration of external modules or plugins that extend the functionality of the core.

In an embodiment, configuration 120 interacts with schema 110 by supporting field-specific behavior during both indexing and querying. For example, configuration 120 may define analyzers that depend on schema 110 field definitions to process incoming text data into tokens or normalized forms. Configuration 120 interacts with index 130 by specifying segment merging policies, replication strategies, and storage optimizations that influence how data is maintained and retrieved. Configuration 120 also defines parameters for request handler 140, including endpoint mappings, query defaults, and transformation rules that affect query interpretation.

In an embodiment, index 130 stores the processed representation of the data ingested by the core. Index 130 is structured to support efficient retrieval operations, often using inverted indices, term dictionaries, and skip lists to optimize query performance. Index 130 may include additional structures, such as columnar storage or payloads, that enhance functionality for advanced use cases, such as analytics or vector-based search. Index 130 can be updated dynamically as new data is ingested or existing data is modified, depending on the configurations set in schema 110 and configuration 120.

In an embodiment, a core is configured to execute a running instance of a core index by managing the lifecycle of an index and interacting with configuration files that define schema properties, query handling, and indexing behavior. A core includes an active index structure, a transaction log, and a set of configuration files stored within a designated directory. A core interacts with an index directory that includes segment files, inverted indexes, and metadata used to support search and retrieval operations. A core is registered within a core container that manages core discovery, configuration loading, and runtime execution. A core container includes a registry of active cores and manages operations related to initialization, shutdown, and reloading.

In an embodiment, core 100 includes a processing entity that executes index 130. Index 130 includes a structured repository of data optimized for search and retrieval operations. Core 100 facilitates interactions with index 130 by providing functionality to both store and query data according to predefined configurations. Configuration 120 defines the schema of the data in index 130, the query handling logic, and operational parameters. Core 100 manages the lifecycle of index 130, such as handling updates, deletions, and queries against the indexed data.

In an embodiment, core 100 acts as a manager that controls the execution of operations related to index 130. This management role includes defining operational rules, providing a framework for input and output of data, and maintaining the integrity of the stored data. Core 100 interacts with request handler 140 and configuration 120 to ensure that requests for data retrieval or updates are executed in accordance with defined operational parameters. The interaction between core 100 and these elements occurs through standardized interfaces, helping the processing pipeline to handle data flow efficiently.

In an embodiment, core 100 facilitates execution of queries by interacting with request handler 140, which transforms user inputs into structured instructions for data retrieval from index 130. Request handler 140 provides parsed and optimized instructions that core 100 uses to extract relevant data from index 130. The retrieved data is subsequently formatted and returned to the requesting entity. The management capabilities of core 100 extend to maintaining consistency across index 130, ensuring that data updates and deletions are propagated according to transactional rules defined by configuration 120.

In an embodiment, core 100 includes functionality for enforcing schema 110, allowing data stored in index 130 to adhere to defined field types, relationships, and constraints. Schema 110 ensures that the structure of index 130 aligns with expected formats and standards for the data. Core 100 interacts with schema 110 as defined in configuration 120 to apply rules to incoming data during indexing operations. These rules determine how data is parsed, stored, and retrieved, ensuring that index 130 remains consistent with operational requirements.

In an embodiment, core 100 supports dynamic updates to configuration 120, allowing modifications to schema 110 or operational parameters without requiring a restart of the system. These updates are applied through defined interfaces that core 100 uses to receive and validate new configurations. Once validated, the updates are propagated to index 130 and request handler 140, supporting adaptation to evolving requirements. Core 100 ensures synchronization between the operational state and the configured state of the system, maintaining alignment across schema 110, configuration 120, request handler 140, and index 130.

In an embodiment, index 130 interacts with schema 110 by organizing stored data according to the field definitions and attributes specified in schema 110. The interaction ensures that indexed data complies with the structural and operational requirements defined in schema 110. Index 130 interacts with configuration 120 by adhering to storage, caching, and update policies defined in configuration 120. During query execution, index 130 works in conjunction with request handler 140 to retrieve and assemble results based on the query parameters and retrieval strategies configured in the core.

In an embodiment, request handler 140 processes incoming queries by interpreting query parameters, executing searches against index 130, and formatting responses for client applications. Request handler 140 may support various query types, including full-text search, range queries, and aggregations, depending on the capabilities defined in configuration 120. Request handler 140 can apply query transformations, such as filtering or boosting, before execution to refine search results.

In an embodiment, request handler 140 interacts with schema 110 by referencing field definitions during query parsing and execution. The interaction ensures that query terms and filters align with the indexed fields defined in schema 110. Request handler 140 interacts with configuration 120 to apply query parsing rules, endpoint mappings, and custom processing logic defined in configuration 120. Request handler 140 interacts with index 130 by issuing structured queries that retrieve relevant data based on the search and filtering criteria specified in the query.

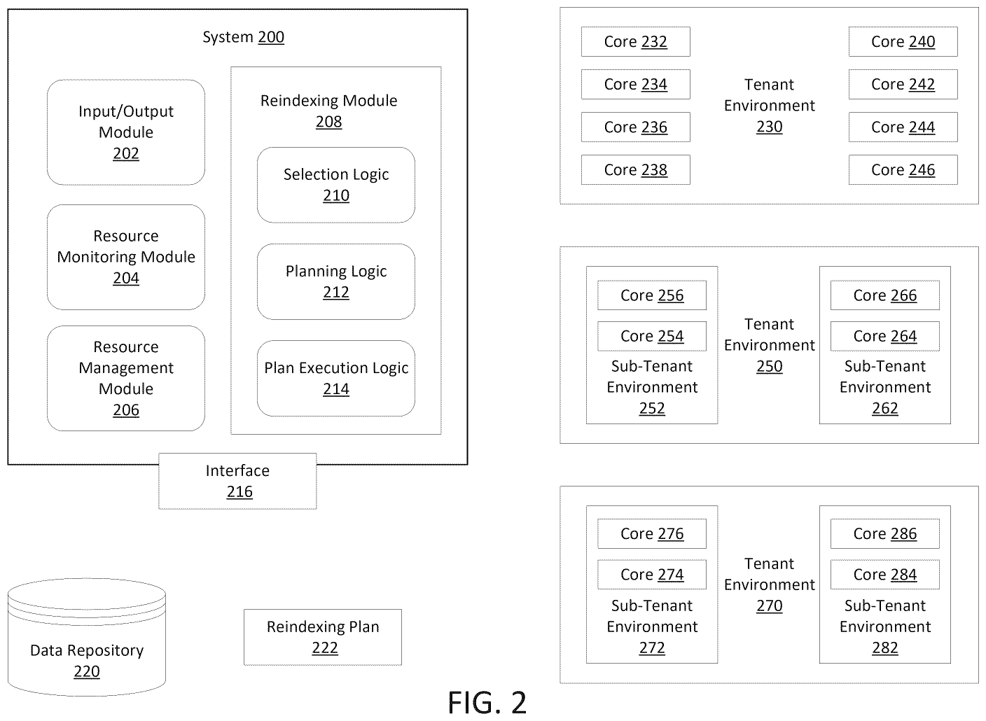

FIG. 2 illustrates a system 200 in accordance with one or more embodiments. System 200 is configured for planning and performing reindexing operations by managing the interaction between multiple modules. In an embodiment, system 200 is a search platform, or part of a search platform, such as Apache Solr. System 200 includes an input/output module 202 that is responsible for handling data communication between system 200 and external components through interface 216. Input/output module 202 manages the receipt of data required for reindexing operations and transmits the results or outputs of those operations to external systems or users. Input/output module 202 can handle data in a variety of formats and protocols, depending on the configuration of interface 216 that serves as the conduit for data flow. The interaction between input/output module 202 and interface 216 ensures that data is properly routed into system 200 for processing and transmitted out after operations are completed.

In an embodiment, input/output module 202 interacts with other modules in system 200 by ensuring that data required for resource monitoring, resource management, and reindexing is made available. Input/output module 202 may collect data from external sources that is then consumed by resource monitoring module 204 to evaluate the status of the environment. Additionally, input/output module 202 can transmit resource utilization data or reindexing results, as determined by resource management module 206 and reindexing module 208, to external systems or users. The interaction between input/output module 202 and the other modules ensures that system 200 can operate with up-to-date information and provide outputs that are aligned with the system's configuration and objectives.

In an embodiment, resource monitoring module 204 is configured to evaluate resource usage within the environment to prevent interference with existing operations during reindexing. Resource monitoring module 204 collects data related to resource availability, such as load, memory usage, storage capacity, and network bandwidth, from the system or environment hosting the reindexing operations or external systems interacting with system 200. The data collected by resource monitoring module 204 may also include usage trends and predictions based on historical data that can be used by other modules to make informed decisions about reindexing.

In an embodiment, resource monitoring module 204 interacts with resource management module 206 and reindexing module 208 by providing resource usage information that informs decisions about scheduling and performing reindexing operations. Resource monitoring module 204 ensures that resource management module 206 has access to current data about the environment. The data about the environment can be used to allocate resources for reindexing without disrupting ongoing operations. Resource monitoring module 204 also informs selection logic 210 within reindexing module 208 about resource constraints or trends that could affect the selection of cores or indexes for reindexing.

In an embodiment, resource management module 206 is configured to manage the allocation and prioritization of resources within the environment to support reindexing operations. Resource management module 206 may implement policies for resource allocation, such as setting thresholds for CPU, memory, or storage usage, and adjusting resource assignments to balance workload demands. Resource management module 206 interacts with resource monitoring module 204 to access real-time and predictive resource usage data, supporting dynamic adjustments to resource allocation based on environmental conditions.

In an embodiment, resource management module 206 interacts with reindexing module 208 by coordinating resource assignments for reindexing operations. Resource management module 206 can provide resource availability information to planning logic 212 to inform the creation of reindexing plan 222. During the execution phase, resource management module 206 may dynamically adjust allocations based on feedback from plan execution logic 214, ensuring that resource usage remains within acceptable limits while reindexing operations proceed.

In an embodiment, reindexing module 208 is responsible for orchestrating reindexing operations through the use of selection logic 210, planning logic 212, and plan execution logic 214. Reindexing module 208 evaluates the environment and determines the cores or indexes that should be reindexed based on various criteria, such as resource usage, data freshness, or anticipated query load. Selection logic 210 selects the cores or indexes to be reindexed by analyzing data provided by resource monitoring module 204 and potentially incorporating predictive models or user-defined criteria.

In an embodiment, selection logic 210 interacts with resource management module 206 and planning logic 212 by providing information about the selected cores or indexes.

Resource management module 206 uses this information to allocate resources for reindexing, while planning logic 212 incorporates the selection data into the creation of reindexing plan 222. The interaction between these components ensures that the cores or indexes selected for reindexing align with the resource constraints and operational goals of system 200.

In an embodiment, planning logic 212 is configured to create reindexing plan 222 by analyzing information from selection logic 210, resource monitoring module 204, and resource management module 206. Planning logic 212 evaluates the cores or indexes selected for reindexing, determining the optimal sequence and configuration for the operations based on resource availability, system constraints, and operational priorities. Planning logic 212 incorporates considerations, such as the size of the cores or indexes, the anticipated duration of reindexing, and dependencies between operations, ensuring that the plan aligns with the overall goals of system 200.

In an embodiment, planning logic 212 interacts with resource management module 206 to incorporate current and projected resource availability into the creation of reindexing plan 222. Planning logic 212 may query resource management module 206 for information about available Central Processing Unit (CPU), memory, and storage resources as well as thresholds or limits defined by system policies. The interaction ensures that the reindexing plan avoids over-allocating resources or creating conflicts with other operations in the environment. Planning logic 212 stores the completed reindexing plan 222 in data repository 220, making it accessible to plan execution logic 214 and other system components for subsequent processing and execution.

In one or more embodiments, a data repository 220 is any type of storage unit and/or device (e.g., a file system, database, collection of tables, or any other storage mechanism) for storing data. Furthermore, a data repository 220 may include multiple different storage units and/or devices. The multiple different storage units and/or devices may or may not be of the same type or located at the same physical site. Furthermore, a data repository 220 may be implemented or executed on the same computing system as system 200. Additionally, or alternatively, a data repository 220 may be implemented or executed on a computing system separate from system 200. The data repository 220 may be communicatively coupled to system 200 via a direct connection or via a network.

In an embodiment, reindexing plan 222 is a structured set of instructions and parameters that defines how reindexing operations will be performed. Reindexing plan 222 specifies the sequence in which cores or indexes will be reindexed, the resources allocated for the operations, and any conditions or constraints that apply during execution. For example, reindexing plan 222 may include information about batch sizes, indexing algorithms, or timing windows to avoid conflicting with peak system usage. Reindexing plan 222 may also include fallback or contingency steps that allow for dynamic adjustments in response to changing conditions in the environment.

In an embodiment, reindexing plan 222 interacts with multiple components of system 200 to guide the execution of reindexing operations. Data repository 220 serves as the storage location for reindexing plan 222, ensuring that the plan is accessible to plan execution logic 214 and other modules. Plan execution logic 214 retrieves reindexing plan 222 from data repository 220 and uses the parameters and instructions defined in the plan to initiate and monitor reindexing operations. Reindexing plan 222 can also be updated or modified by planning logic 212 if adjustments are needed based on feedback from resource monitoring module 204 or resource management module 206.

In an embodiment, plan execution logic 214 executes reindexing plan 222 by initiating and managing the steps defined in the plan. Plan execution logic 214 interacts with the cores or indexes selected for reindexing, applying the configurations and parameters specified in reindexing plan 222 to perform the necessary operations. Plan execution logic 214 may handle various tasks, such as reading data from the existing index, transforming the data as required by schema definitions, and writing the transformed data into the new index structure. Plan execution logic 214 monitors the progress of reindexing operations, capturing various metrics, such as completion percentage, resource usage, and error rates.

In an embodiment, plan execution logic 214 interacts with resource management module 206 and resource monitoring module 204 during the execution phase to ensure that resource usage remains within acceptable limits. Resource management module 206 provides updated resource allocations as needed, while resource monitoring module 204 supplies real-time data about resource usage and availability. Plan execution logic 214 uses this information to make adjustments during execution, such as pausing or throttling operations to avoid resource contention. Plan execution logic 214 may also provide feedback to planning logic 212, supporting dynamic updates to reindexing plan 222 if unexpected conditions arise during execution.

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant identifier (ID). Each network resource of the multi-tenant computer network is tagged with a tenant ID. A tenant is permitted access to a particular network resource when the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, multiple tenants may share the database.

In an embodiment, a tenant environment may include one or more sub-tenant environments. An environment represents a defined logical context within a computing system that encompasses resources, configurations, and operational boundaries for a specific entity or purpose. This logical context may include network infrastructure, storage, compute resources, applications, and associated configurations that collectively support the operations of the entity. A sub-tenant environment is a logical division within a tenant environment, representing a subset of the tenant environment's operations, organizational units, or end users. Sub-tenant environments may have distinct requirements for computing services, such as specific applications, data access permissions, or network configurations. For example, a tenant environment may represent a corporation, and sub-tenant environments may represent departments, regional offices, or teams within that corporation. Sub-tenant environments can help segregate operations, improve manageability, and enforce fine-grained access controls in a multi-tenant computer network.

In an embodiment, sub-tenant environments may be associated with unique sub-tenant environment IDs that are tagged to the network resources, applications, and data relevant to that sub-tenant. Access to these resources is restricted to users or processes that belong to the sub-tenant and possess the appropriate sub-tenant environment ID. In this way, sub-tenant environments are isolated from each other, similar to how tenant environments are isolated in a multi-tenant computer network. This isolation ensures that the applications and data of one sub-tenant are not shared with or accessible to other sub-tenants, thereby maintaining data security and privacy. An environment, whether a tenant or sub-tenant environment, provides a mechanism for logically grouping and controlling resources while maintaining operational boundaries and ensuring compliance with security and governance policies.

A tenant may define policies for its sub-tenants to specify their access to shared and dedicated resources. For example, while a tenant may allocate a shared database to multiple sub-tenants, the sub-tenants'access may be restricted to the database entries tagged with its sub-tenant ID. Similarly, a tenant may provision specific applications or virtual machines for exclusive use by a sub-tenant. Such configurations allow sub-tenants to operate semi-independently within the boundaries set by the tenant, supporting flexible and scalable resource utilization across diverse organizational units.

FIG. 2 further illustrates an example of relationships between tenants and sub-tenants in accordance with one or more embodiments. Specifically, FIG. 2 illustrates tenant environment 230, tenant environment 250, and tenant environment 270. Tenant environment 230 includes core 232, core 234, core 236, core 238, core 240, core 242, core 244, and core 246. Tenant environment 250 includes sub-tenant environment 252 and sub-tenant environment 262. Sub-tenant environment 252 includes core 256 and core 254. Sub-tenant environment 262 includes core 266 and core 264. Tenant environment 270 includes sub-tenant environment 272 and sub-tenant environment 282. Sub-tenant environment 272 includes core 276 and core 274. Sub-tenant environment 282 includes core 286 and core 284.

In an embodiment, the system includes these tenant environments, sub-tenant environments, and cores, which collectively provide a hierarchical framework for organizing and managing computational resources in a distributed computing system. Each tenant environment defines a logical boundary representing an isolated operational domain for a specific tenant. This boundary encapsulates the resources, services, and configurations required for that tenant's operations. Tenant environments are independent of each other, ensuring that the operations, data, and configurations of one tenant environment do not affect or interfere with those of another.

In an embodiment, each tenant environment may include multiple sub-tenant environments, which are logical subdivisions within the tenant environment. Sub-tenant environments provide further isolation and customization by supporting resource allocation, configuration, and access control specific to subsets of the tenant's organizational structure or operational requirements. For example, sub-tenant environment 252 and sub-tenant environment 262 within tenant environment 250 could correspond to different departments, regions, or functional units of a tenant organization. These subdivisions facilitate the segregation of operations, allowing each sub-tenant environment to operate independently while adhering to the policies and resource limitations defined at the tenant environment level.

In an embodiment, cores within tenant environments and sub-tenant environments represent the functional processing units responsible for performing key computational tasks. Each core is an independent entity that manages its assigned resources, such as data, processing power, and network configurations, in accordance with the policies defined by its parent environment. For example, core 232, core 234, and the other cores in tenant environment 230 may handle tasks such as indexing, data storage, and query execution. Within sub-tenant environments, cores such as core 254 and core 256 in sub-tenant environment 252 manage workloads that are specific to the sub-tenant environment, providing granular control over operations and resource allocation.

In an embodiment, the hierarchical relationships among tenant environments, sub-tenant environments, and cores establish clear operational boundaries and interactions. Tenant environments encapsulate sub-tenant environments, providing a logical structure for resource management and operational oversight. Sub-tenant environments, in turn, encapsulate their respective cores, ensuring that computational tasks are executed within the context of the defined policies and access controls of the parent environment. This encapsulation ensures isolation between components at every level of the hierarchy, maintaining the integrity, security, and scalability of the system.

In an embodiment, cores interact with configuration data to execute assigned tasks. Configuration data may define operational parameters, resource allocations, and data access rules specific to each core. For instance, core 256 in sub-tenant environment 252 may execute operations that are configured to align with the access permissions, data formats, and processing requirements of the sub-tenant environment. Similarly, cores within tenant environments, such as core 232 in tenant environment 230, interact with configuration data that governs the operations of the entire tenant environment. These interactions ensure that the system's operations remain consistent with the policies and constraints defined at the appropriate hierarchical level.

In an embodiment, the system's structure supports scalability and flexibility by allowing the addition or modification of tenant environments, sub-tenant environments, and cores without affecting the operation of existing components. For instance, additional cores can be assigned to a sub-tenant environment to handle increased workload demands, or new sub-tenant environments can be instantiated within a tenant environment to support organizational growth or new operational requirements. The encapsulated nature of the system's components ensures that these changes remain confined to the relevant parts of the hierarchy, minimizing disruption and maintaining system stability.

In an embodiment, this hierarchical organization of tenant environments, sub-tenant environments, and cores provides a robust foundation for managing resources, operations, and data in a multi-tenant computing system. By defining clear boundaries and interactions between components, the system supports operational isolation, granular resource control, and compliance with governance policies.

In one or more embodiments, the system 200 may include more or fewer components than the components illustrated in FIG. 2. The components illustrated in FIG. 2 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

Information associated with data repository 220, such as reindexing plan 222, may be implemented across any of components within the system 200. However, this information is illustrated within the data repository 220 for purposes of clarity and explanation.

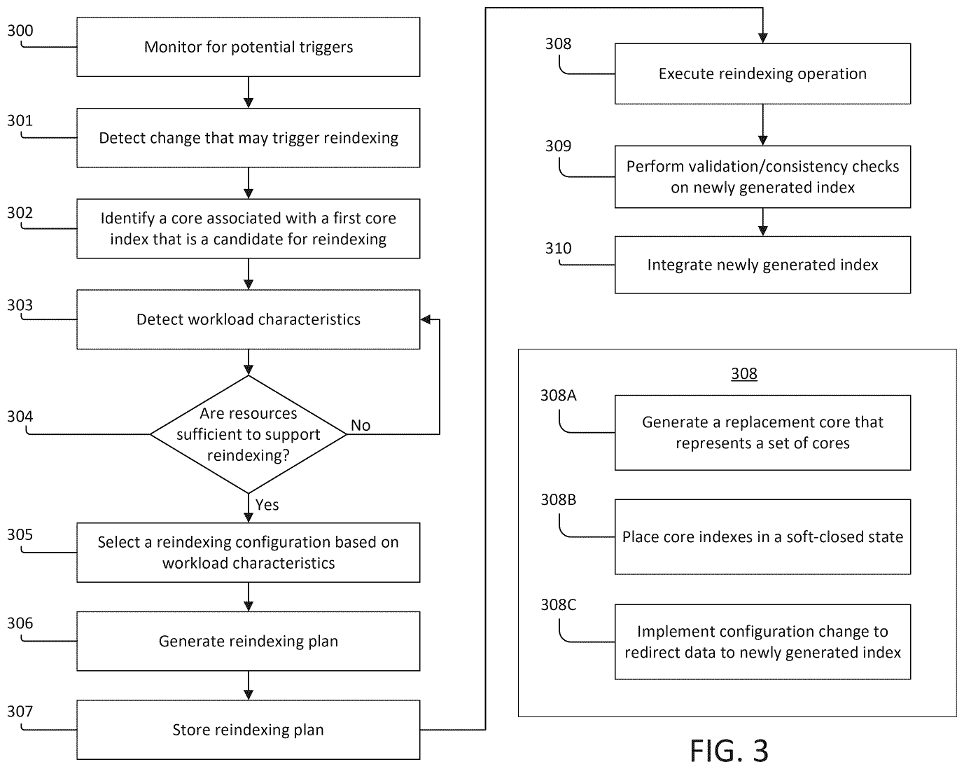

In one or more embodiments, system 200 refers to hardware and/or software configured to perform operations described herein for system 200. Examples of operations for system 200 are described below with reference to FIG. 3.

In an embodiment, system 200 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 216 refers to hardware and/or software configured to facilitate communications between a user and system 200 or between another system and system 200. Interface 216 may render user interface elements and receive input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 216 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 216 is specified in one or more other languages, such as Java, C, or C++.

### 3. Performing a Reindexing Operation

FIG. 3 illustrates an example set of operations for performing a reindexing operation in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In an embodiment, a system (e.g., the system of FIG. 1) monitors the environment for potential triggers for a reindexing operation (Operation 300). Potential triggers for a reindexing operation may include, as non-limiting examples: (a) version incompatibilities; (b) schema changes; (c) data integrity issues; (d) performance optimization requirements; and/or (e) updates to data sources and/or new data. Each of these examples is discussed in further detail below. To monitor the environment for potential triggers, the system may periodically query or listen for updates to version metadata, schemas, and/or other information associated with the index.

a. Version Incompatibilities

In an embodiment, incompatibilities in index versions (for example, resulting from software upgrades) may trigger reindexing operations. Major version upgrades of the engine may introduce changes in how data is structured, indexed, or stored, making existing indexes incompatible with the new version. For example, updates to underlying data structures, such as inverted indexes or term dictionaries, may render older indexes unreadable or inefficient in the upgraded system. These incompatibilities may necessitate reindexing to rebuild the index using the updated format and ensure compatibility with the upgraded search engine instance. Without reindexing, queries and updates against the outdated index may fail or produce inconsistent results.

In an embodiment, the system accesses a centralized repository, configuration file, or database where version identifiers are stored. Alternatively or additionally, the system may interact with one or more external systems, such as source control repositories or database triggers, to receive notifications of changes to version identifiers. A version identifier is a structured value that represents the state or configuration of a particular index, schema, or data source at a given point in time. The version identifier may be encoded as a hash, timestamp, sequential number, or a combination thereof, and it is generated based on attributes, such as schema definitions, field mappings, or indexing configurations. The system may maintain a reference to the last known version identifier for comparison purposes. The system may use checksum calculations or hashing algorithms to independently compute a version identifier by analyzing the structure or content of the schema, index, or associated configuration files.

In an embodiment, the system detects discrepancies between the current version identifier and the stored reference version identifier by performing a direct comparison. For instance, the system may retrieve the current identifier from the index metadata and compares it against the reference stored in memory or a persistent data store. If the two identifiers differ, the system concludes that a change has occurred. This comparison process may involve extracting identifiers from multiple sources, such as schema definitions, index mappings, or file headers, to ensure accuracy and consistency in detecting changes.

In an embodiment, the system may employ additional verification techniques to validate the detected change in the version identifier. These techniques include cross-referencing related metadata, such as timestamps or user modification logs, to confirm that the observed change is authentic and not the result of a transient error or incomplete update. The system may also use audit logs or event streams to track historical changes in version identifiers, helping it to identify patterns or sequences of updates that might indicate an intentional modification. By integrating these validation steps, the system ensures that detected changes in version identifiers reflect actual updates to the index or schema.

b. Schema Changes

In an embodiment, changes to the schema configuration may trigger reindexing operations. Schema changes such as adding new fields, modifying field types, or altering field properties such as analyzers or tokenizers, can create inconsistencies between the stored data and the new schema. For example, changing a field type from a string to a text field may require reprocessing the data to apply new tokenization or analysis rules. Similarly, adding new fields for searching or reporting purposes often requires reindexing to populate the new fields with data extracted from the original documents. These schema-related triggers occur because the existing index does not reflect the updated schema definitions.

In an embodiment, the system may detect a schema change by monitoring one or more schema configuration files and/or schema API responses associated with the search system. The schema defines the structure and properties of fields used within the index, including data types, analyzers, tokenizers, and field-specific behaviors. Changes to the schema may be made programmatically via schema APIs or manually by updating the schema configuration files. The system identifies such changes by maintaining a reference to the current schema state and periodically comparing it to the observed schema configuration.

In an embodiment, the system retrieves the schema configuration by querying the schema API or directly accessing the schema file, such as schema.xml or managed schema, in a compatible system. The system may use a checksum or hash function to calculate a unique identifier for the schema's content, including field definitions, dynamic field rules, and field type configurations. This identifier serves as a fingerprint of the schema, allowing the system to detect any modifications by comparing the calculated identifier with a stored reference value.

In an embodiment, the system detects discrepancies in the schema by comparing the structure and attributes of the retrieved schema with the stored schema reference. This comparison may involve evaluating the presence, absence, or modification of fields, data types, or analyzers. For example, the system may detect that a new field has been added, an existing field's type has been changed, or an analyzer has been updated for a specific field. Such changes can affect indexing and querying behaviors, prompting the system to log or register the change for further processing.

In an embodiment, the system validates schema changes by cross-referencing additional metadata or logs. For example, the system may inspect timestamps, user activity logs, or versioning metadata associated with the schema file to confirm that the observed changes are valid and intentional. When working in a distributed environment, the system may also query multiple nodes to ensure schema consistency across the cluster. Discrepancies between nodes or inconsistent metadata may indicate a partial or incomplete schema update, requiring further validation.

In an embodiment, the system may detect schema changes by integrating with external version control or configuration management systems. Schema files stored in a version-controlled repository, for example, can be monitored for changes using hooks or polling mechanisms. When a schema file is updated, the system retrieves the latest version from the repository and compares it to the currently loaded schema in the search system. This approach ensures that schema changes, whether made programmatically or manually, are detected and accounted for.

c. Data Integrity Issues

In an embodiment, data integrity issues may trigger reindexing operations. Corruption in the index, often caused by system failures, such as abrupt shutdowns or storage device errors, can lead to incomplete or inaccessible data. Reindexing is necessary in such cases to restore the integrity of the index by rebuilding it from the original source data. Additionally, scenarios where misconfigured schema definitions or processing pipelines result in incorrect data being indexed can also prompt reindexing operations. Correcting these issues at the schema or pipeline level and reindexing the data ensures that the index accurately reflects the intended structure and content.

d. Performance Optimization Requirements

In an embodiment, the system monitors performance optimization requirements that trigger reindexing operations. Over time, incremental updates to an index, such as document additions, deletions, or modifications, can result in fragmented data structures that degrade query performance. Although some search platforms (e.g., Apache Solr) employ techniques to mitigate this fragmentation, reindexing provides a comprehensive way to optimize the index. By rebuilding the index from scratch, reindexing ensures that the data is stored in a compact and efficient format, improving query execution times and reducing resource consumption. Performance triggers for reindexing are often identified through monitoring metrics, such as query latency or system resource utilization.

e. Updates to Data Sources and/or New Data

In an embodiment, updates to data sources and/or the introduction of new data may trigger reindexing operations. For example, if a search engine core is used to index data from a relational database, significant changes to the database schema, such as adding or renaming columns, can require reindexing to align the search index with the updated source. Similarly, if a new dataset is integrated into the system, reindexing may be performed to incorporate the new data while ensuring consistency in how existing and new documents are indexed. These data-related triggers often arise in dynamic environments where data structures evolve to accommodate new business requirements or use cases.

Continuing with the discussion of FIG. 3, the system may monitor for potential triggers (Operation 300) until it detects a change that may trigger reindexing (Operation 301). In an embodiment, responsive to detecting the potential trigger, the system identifies that a core associated with a first core index that is a candidate for reindexing (Operation 302). For example, when the system detects a version change, schema change, or other trigger, the system identifies a core that is a candidate for reindexing by analyzing metadata and configuration details stored within the system. The system may query a centralized repository or service to retrieve information about the cores managed within the environment, including their current schema, version identifiers, and index configurations. Using this information, the system evaluates the relationship between the detected trigger and the properties of the cores. For example, if a schema change is detected, the system determines if the modified schema is associated with a particular core by cross-referencing schema-to-core mappings. Similarly, if a version change is detected, the system examines version metadata for the cores to identify those using an incompatible or outdated version.

In an embodiment, the system identifies a core index as a candidate for reindexing if the metadata or configuration of the core aligns with the conditions specified by the trigger. For instance, if the trigger involves an incompatible index format introduced by a software upgrade, the system checks the index metadata for format identifiers and flags cores that do not comply with the updated format. For schema changes, the system inspects the schema definitions tied to the cores, identifying cores with fields, types, or analyzers impacted by the change. Once a core is identified as meeting the criteria, the system marks the core index as a candidate for reindexing, and this information is stored for further processing.

In an embodiment, in a multi-tenant environment with sub-tenants, the system performs additional steps to identify multiple cores impacted by the detected trigger. The cores are associated with metadata that includes tenant and sub-tenant identifiers that the system uses to evaluate the scope of the change. If the trigger affects a parent tenant, the system retrieves cores associated with that tenant, including those belonging to sub-tenants that inherit configurations from the parent. Conversely, if the trigger applies to a specific sub-tenant, the system isolates cores tagged with the corresponding sub-tenant ID and excludes cores associated with other sub-tenants or unrelated tenants. If the trigger affects a parent tenant, the retrieval process identifies cores that belong to the parent and that extend to sub-tenants inheriting the parent's configurations. If the trigger applies to a specific sub-tenant, the retrieval process filters the cores based on the sub-tenant ID, ensuring that unrelated cores are excluded. Depending on the system's architecture, the retrieval process may fetch configuration files, resolve core locations within storage or memory, and/or interface with the core container to determine active instances.

In an embodiment, retrieving a core for reindexing refers to the process of accessing the core's configuration, operational state, and associated data to prepare for and execute reindexing operations. A core represents a processing entity that manages an index, along with its schema, configurations, and related resources. Retrieving a core for reindexing involves identifying and loading the specific core that requires reindexing, typically based on a core identifier or other selection criteria.

Retrieving a core for reindexing includes accessing the core's metadata, including the schema and configuration files, to understand the structure of the data and the rules that govern indexing. This step ensures that reindexing operations adhere to the defined schema and any constraints or field definitions. Additionally, the retrieval process may include establishing access to the underlying storage or data source associated with the core to support the reindexing system to read and reprocess the relevant data.

During retrieval, the system may also assess the current state of the core, such as its operational status, version, or existing index integrity, to determine any prerequisites for reindexing. For example, a core that is actively handling queries may require a coordination step to prevent disruptions during reindexing. The retrieved core is then made available to execution modules that perform the actual reindexing tasks, such as indexing new data, rebuilding existing indexes, or applying updated schema definitions. This process ensures that the core is properly prepared and aligned with the objectives of the reindexing operation.

In an embodiment, the system leverages hierarchical metadata to map relationships between parent tenants and their sub-tenants, ensuring that relevant cores are identified based on the nature of the trigger. For example, if a schema update introduces a new field at the parent-tenant level, the system evaluates if sub-tenants inherit the updated schema or maintain their own schema overrides. The system identifies cores that inherit the updated schema and adds them to the list of candidates for reindexing, while cores with overridden schemas are evaluated separately based on their unique configurations.

In an embodiment, a cloud service provider managing reindexing operations uses tagging mechanisms to track ownership and configuration details for cores. Cores are tagged with identifiers, such as tenant ID, sub-tenant ID, and customer ID, that the system queries to isolate cores impacted by a specific trigger. For example, when a version change is detected, the system queries the cores tagged with the affected version identifier to determine the cores that require reindexing. The system cross-references these cores with tenant and sub-tenant metadata to accurately identify the scope of the change, ensuring that relevant cores are flagged for further action.

In an embodiment, the system detects workload characteristics (Operation 303). For example, the system may detect workload characteristics associated with the environment by collecting and analyzing metrics from various sources, such as system logs, resource monitoring tools, and telemetry data. These workload characteristics may include various metrics such as CPU utilization, memory consumption, disk I/O, network throughput, and the number of active queries or indexing operations currently in progress. The system associates these metrics with specific cores, tenants, and sub-tenants by referencing tagging mechanisms and/or metadata that map resources to their respective owners. The workload analysis may identify patterns, such as peak activity times or usage trends, that influence resource availability and operational stability.

In an embodiment, the system determines if resources are sufficient to support a reindexing operation (Operation 304). The system may consider resources allocated to tenants and sub-tenants when evaluating the impact of reindexing operations on cores that are candidates for reindexing. The system retrieves allocation information, such as quotas for CPU, memory, and storage, as well as current utilization levels for the tenancies and sub-tenants. By correlating this information with the workload characteristics, the system determines if resources are sufficient to support reindexing without disrupting ongoing operations. For instance, if a candidate core is associated with a sub-tenant operating under a high current load, the system evaluates the potential for contention or performance degradation during the reindexing process. Based on these factors, the system may determine that enough resources are available to support a reindexing operation. Alternatively, the system may determine that resources are not sufficient. If resources are not available or otherwise insufficient to perform a reindexing operation, the system may continue to detect and monitor workload characteristics until enough resources are available to support a reindexing operation. Alternatively or additionally, the system may halt the reindexing operation, log an error, and/or generate an alert that the reindexing operation failed.

In an embodiment, the system assesses the potential impact of reindexing operations on candidate cores by simulating or estimating resource requirements for the reindexing tasks. This assessment may involve calculating the anticipated CPU cycles, memory footprint, and disk usage based on the size of the core's index, the complexity of the schema, and the type of analyzers or tokenizers applied during indexing. The system compares these estimated requirements against the detected workload characteristics and the resources available to the cores'associated tenants and sub-tenants. The system identifies potential conflicts, such as resource exhaustion or delays in serving active queries, and notes these as part of the reindexing evaluation.

In an embodiment, the system incorporates the hierarchical structure of tenants and sub-tenants when analyzing the impact of reindexing. For cores associated with a parent tenant, the system considers the aggregated resource usage across sub-tenants that share resources with the parent. Conversely, for cores associated with individual sub-tenants, the system evaluates the localized impact of reindexing within the boundaries of the sub-tenant's allocated resources. This hierarchical approach ensures that the system accounts for dependencies and interactions between tenants and sub-tenants that could amplify the resource demands or consequences of a reindexing operation.

In an embodiment, the system evaluates environmental factors that may exacerbate the impact of reindexing operations, such as scheduled maintenance, concurrent indexing tasks, or high-priority workloads. These factors are integrated into the assessment of workload characteristics to provide a comprehensive view of the environment. By combining data on resource usage, tenant and sub-tenant allocations, and external conditions, the system establishes a detailed understanding of the potential impact of reindexing operations on candidate cores within the multi-tenant environment.

In an embodiment, the system generates and maintains one or more reindexing impact metrics for the cores, representing a quantitative measure of the resource impact associated with reindexing the index linked to the core. This metric may be calculated based on several factors, including the size of the index, the complexity of the schema, the data volume to be processed, and the specific transformations or analyzers applied during reindexing. For example, larger indexes typically require more CPU cycles and memory to process, while complex schemas with multiple fields, tokenizers, and filters may increase the computational load during the reindexing operation. In an embodiment, there may be more than one reindexing impact metric. In an embodiment, reindexing impact metrics may be composite metrics identifying more than one impact measurement (e.g., a combination of CPU utilization and memory utilization), or reindexing impact metrics may be associated with one detailed measurement. Furthermore, a combination of composite metrics and focused metrics may identify only one measurement (e.g., CPU utilization).

In an embodiment, a reindexing impact metric may incorporate historical performance data, such as previous reindexing times, resource usage patterns, and observed system behavior during prior operations. Historical data can provide insights into the expected load and duration of a reindexing task, allowing the system to better estimate the impact on system resources. For instance, a core that historically required high disk input-output (I/O) or memory during reindexing may have a higher impact metric than a core with simpler indexing requirements.

In an embodiment, the reindexing impact metric may also factor in the current workload characteristics of the environment, including the utilization of shared resources, such as CPU, memory, and storage. For cores in multi-tenant environments, the metric may consider resource contention caused by other tenants or sub-tenants operating on the same infrastructure. For example, a core with high expected resource demands may have a lower impact metric if the associated tenant has sufficient unused resources, whereas the same core may have a higher metric in a resource-constrained environment.

In an embodiment, the reindexing impact metric may be influenced by tenant and sub-tenant hierarchies with additional considerations for dependencies and inherited configurations. For instance, cores associated with parent tenants that have cascading schema changes to sub-tenants may include the cumulative resource impact of reindexing both parent and sub-tenant cores. Similarly, the metric may account for cores with sub-tenant-specific configurations that require separate or additional processing, increasing the calculated impact.

In an embodiment, the reindexing impact metric may also incorporate environmental variables, such as the availability of network bandwidth, scheduled maintenance windows, or concurrent high-priority workloads. For example, if a core's reindexing is expected to coincide with peak usage periods or other resource-intensive operations, the impact metric may reflect the additional strain on the system. By integrating these diverse factors, the reindexing impact metric provides a comprehensive representation of the resource demands and potential effects associated with reindexing the index of the cores.

In an embodiment, during the planning phase, the system determines a reindexing impact metric based on the most likely reindexing operation structure for the logically separated set of cores. For example, rather than indexing the cores separately, the system may determine that efficiency may be gained by performing a reindexing operation on a set of related core indexes even if they are associated with different cores. For example, by creating a single replacement core representing time T0 to T3 as discussed above, the system has fewer to take during the reindexing operation. During the planning phase, scenarios such as this are considered and used to determine if the best type of reindexing operation (e.g., individual or composite reindexing) should be performed concurrently with other reindexing operations, particularly those reliant on the same resources.

In an embodiment, once the system, determined that there are enough resources available to support a reindexing operation, the system generates and/or selects a reindexing configuration based on the workload characteristics (Operation 305). For example, the system may ensure that cores are prioritized based on tenant and sub-tenant relationships as well as the operational requirements of the associated customers. For example, customers may have service-level agreements, or parent-tenant cores may need to be reindexed before their sub-tenants'cores. The system may leverage defined resource allocation policies to group and sequence the reindexing of cores based on these priorities while ensuring that cores belonging to different tenants or sub-tenants remain isolated. For example, a resource allocation policy may indicate the service level requirements associated with resources for tenants or other grouping that is associated with a distinct set of cores. This approach allows the system to scale reindexing operations across a large number of cores in a controlled and tenant-aware manner.

In an embodiment, the system determines the impact of a reindexing operation on one or more tenants or sub-tenants based at least in part on data collected by one or more resource monitoring modules (e.g., resource monitoring module 206 of FIG. 2). For example, a tenant that has multiple sub-tenants that are unaware of each other may have certain resource constraints, such as memory or processing constraints. Simultaneously performing a reindexing operation on cores associated with sub-tenants may result in reaching the resource constraint of the tenant. This may affect both sub-tenants involved in the reindexing operation and sub-tenants that do not have cores with indexes being reindexed due to the shared resource environment. However, a separate tenant may be unaffected due to the allocation of different resources for the separate tenant.

In an embodiment, the reindexing configuration indicates the resources that may be allocated for the indexing operation on a per-tenant and/or a per-sub-tenant basis. For example, resource constraints that may be used for a reindexing operation for one tenancy may differ from resource constraints that may be used for a reindexing operation for another tenancy due to a variety of factors. For example, one tenancy generally may have very few resource constraints, resulting in little impact on applications or other resources that are reliant on tenancy resources, while another tenancy may have stricter resource constraints. The stricter constraints and other resource-related data will be considered when generating a reindexing configuration.

In an embodiment, the reindexing configuration includes a reindexing plan. The system may generate the reindexing plan, taking into consideration the resource constraint information, expected resource usage, tenancy separation, and other resource-related issues. The system generates a plan that indicates the tenants and/or sub-tenants that will tolerate reindexing operations, when the reindexing operations can be tolerated, and how many reindexing operations may be tolerated.

In an embodiment, the system generates a reindexing plan using the reindexing impact metric or raw data related to resource requirements, workload characteristics, and core configurations (Operation 306). The system analyzes the reindexing impact metrics for candidate cores to determine the order, timing, and resource allocation for reindexing operations. Core impact metrics provide a quantitative measure of the potential impact, helping the system to optimize the sequencing of reindexing tasks to minimize disruption to ongoing operations. Alternatively, raw data, such as index size, schema complexity, and resource usage trends, may be used directly to evaluate the feasibility and scheduling of reindexing tasks.

In an embodiment, the system incorporates tenant and sub-tenant hierarchies into the reindexing plan by grouping and organizing reindexing tasks based on relationships between cores. For example, if schema changes cascade from parent tenants to sub-tenants, the system ensures that reindexing for parent cores is scheduled before dependent sub-tenant cores to maintain consistency. The system evaluates resource usage and availability at both the tenant and sub-tenant levels, adjusting the reindexing plan to account for shared or limited resources within the environment.

In an embodiment, the reindexing plan specifies detailed parameters for reindexing operations, such as the order of execution, the reindexing operations that may occur in parallel, allocated resources, and timing. For cores with high impact metrics, the plan may allocate additional CPU, memory, or storage resources to ensure efficient processing. Timing may be adjusted to avoid peak usage periods, ensuring that reindexing operations do not interfere with active queries or other resource-intensive tasks. The plan also accounts for dependencies between cores, scheduling reindexing tasks in an order that respects tenant and sub-tenant relationships as well as operational priorities.

In an embodiment, the system uses raw data to complement the impact metrics when generating the reindexing plan. For instance, if specific environmental conditions, such as scheduled maintenance or high-priority workloads, are detected, the system adjusts the plan dynamically to avoid resource conflicts. The plan incorporates this contextual information to refine the scheduling and resource allocation for reindexing tasks, ensuring that the operations align with the current state of the environment.

In an embodiment, the system stores the reindexing plan in a data repository (Operation 307). Storing the reindexing plan makes it accessible to execution modules and monitoring systems. The plan may be stored in a variety of formats. For example, in an embodiment, the plan is serialized into a structured format, such as JavaScript Object Notation (JSON), Extensible Markup Language (XML), or a similar schema, and written to the repository as a data object. This object includes fields that specify the reindexing parameters, including source data locations, indexing priorities, scheduling details, and any dependencies on other processes. Metadata associated with the plan, such as timestamps and version identifiers, is also stored alongside the plan to ensure traceability and allow updates. Access to the stored reindexing plan is managed through repository interfaces that support query, retrieval, and update operations, ensuring that the plan can be accessed and modified as needed.

In an embodiment, the plan serves as a centralized reference for coordinating reindexing operations, with entries detailing the scope, schedule, and resources assigned to tasks. The plan may also include contingency steps, such as fallback options or recovery procedures, to address potential issues that could arise during execution. By leveraging the reindexing impact metric or raw data, the system generates a comprehensive and adaptable plan to manage reindexing operations efficiently across multi-tenant environments with sub-tenants. In an embodiment, the system executes a reindexing operation based on the reindexing configuration and the reindexing plan (Operation 308).

In an embodiment, the reindexing operation includes generating a replacement core that represents a set of cores (Operation 308A). For example, a tenant may have a set of cores that represent a distinct time period. During the reindexing operation, the replacement core may be used to represent the time periods associated with the cores being reindexed. Once the replacement core takes the place of the initial set of cores, the time periods covered by the initial set of cores will be restricted to being represented/representation by one core. Time is just one attribute that can be associated with a core; additional attributes may be used to consolidate cores and core indexes.

In an embodiment, core indexes that are being reindexed may be placed in a soft-closed state (308B). Data may be read from an index that is in a soft-closed state, but no data may be written to an index that is in a soft-closed state. By placing indexes in a soft-closed state, the indexes may still be useful for certain operations during the reindexing process.

In an embodiment, a configuration change may be implemented in the search engine and/or platform that redirects data (308C). A configuration change may cause incoming index data to be redirected to the new core based on the attribute. For example, a first core may be associated with the time period T0 to T1, a second core may be associated with the time period T1 to T2, and a third core may be associated with the time period T2 to T3. As part of a reindexing operation, a replacement core may be created, and a configuration change may be initiated that causes index data that would otherwise go to the indexes associated with the first, second, or third core to be redirected to the replacement core. The replacement core represents T0 to T3 once the reindexing operation is complete. In this way, cores, and by extension core indexes, may be combined during a reindexing operation based on attributes or metadata associated with the core or core index.

In an embodiment, the reindexing operation results in an index of the new version by reconstructing the data in the format, structure, and configuration defined by the updated schema, system version, or other triggering changes. The operation involves processing the source data or documents through the indexing pipeline, applying any transformations, analyzers, or tokenizers specified in the updated schema. The resulting index conforms to the new version's specifications, ensuring compatibility with the system's current capabilities and configurations.

In an embodiment, reindexing identifies the source of the data to be reindexed, which may include original document repositories, database exports, or an existing index that requires conversion. The data is ingested into the system, where it undergoes validation and transformation based on the rules defined in the updated schema. Fields, analyzers, and tokenizers are applied in accordance with the new configuration to generate the revised index entries that are written into a new storage location to maintain separation from the existing index during the operation.

In an embodiment, the resulting index reflects the updated schema or configuration with fields and data structures aligned to the new version's requirements. For example, if a schema update introduced a new field, the reindexed documents include the corresponding field values, populated according to the data extraction, or defaulting rules specified during reindexing. Similarly, if the system detects changes in field types or analyzers, the new index incorporates these changes, ensuring that future queries and operations are processed accurately.

In an embodiment, the system may perform validation checks and consistency checks on the newly generated index to ensure that it meets the requirements of the new version (Operation 309). These checks may include verifying the presence and structure of fields, ensuring data integrity, and confirming compatibility with the updated system. Any discrepancies or issues identified during validation are logged by the system, and corrective actions, such as partial reprocessing or targeted updates, may be initiated to resolve them.

In an embodiment, the system integrates the new version of the index into the system by replacing or supplementing the existing index, depending on the operational requirements (Operation 310). The integration process may involve redirecting queries to the new index, updating metadata or configuration files to reference the new version, and decommissioning the previous version of the index once it is no longer needed.

In an embodiment, different cores may be used by the system to manage indexes associated with data partitioned by time periods, such as log files separated by month, year, or other temporal intervals. The cores are associated with an index that corresponds to a specific time slice, supporting efficient organization and retrieval of time-based data. This partitioning approach allows the system to manage large datasets by distributing them across multiple cores, reducing the size and complexity of individual indexes while facilitating operations, such as time-based queries or archival.

In an embodiment, reindexing operations may be performed by the system in stages. For example, the reindexing plan may indicate that a first set of reindexing operations may safely and efficiently be performed concurrently during a first stage. The reindexing plan may be configured to initiate performance of a second set of reindexing operations during a second stage once the first stage has completed. Alternatively, the reindexing plan may be configured to initiate performance of a second set of reindexing operations during a second stage once a pre-defined portion of the first stage has completed or after a particularly resource-intensive operation has completed.

In an embodiment, some or all reindexing operations may be paused if certain conditions are met. For example, if compute resources reach a threshold that may result in a performance impact to a running process within a tenancy, reindexing operations may be paused. Alternatively, the system may throttle the resource usage of the reindexing operation(s) to ensure that adequate resources are available for the detected application.

In accordance with an embodiment, the system may generate multiple reindexing plans and assign the reindexing plan to a composite reindexing plan. By separating reindexing plans into logically separated cores, tenants or sub-tenants, a greater focus may be placed on ensuring the completion of the reindexing operations on a per-tenant basis. For example, a first and second core may be associated with a first tenant, and a third and fourth tenant may be associated with a second tenant. A reindexing plan may be associated with each core, and a composite reindexing plan may indicate that the first and third core indexes should be part of a first stage, and the second and fourth core indexes should be part of a second stage. This separation ensures that the system performs one reindexing operation for a core on each tenant, avoiding a potential overuse of resources on any one tenant. When reindexing plans are created on a per-tenant basis or a per-sub-tenant basis, each reindexing plan may reference any number of cores and/or core indexes.

In an embodiment, some reindexing operations have no dependencies on other reindexing operations. For example, if only one reindexing operation is to be performed on a particular tenant, then that reindexing operation may be subject to resource constraints but not subject to waiting for a particular stage to initiate the reindexing operation.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

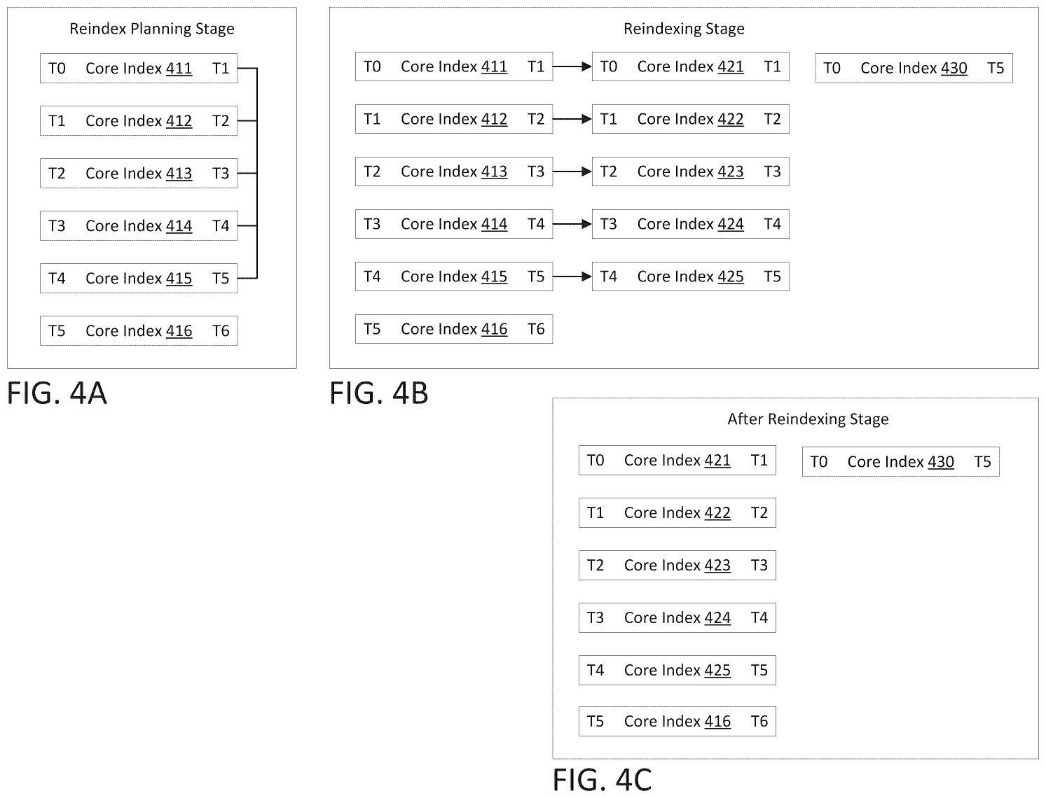

FIG. 4A illustrates an example set of core indexes at the reindex planning stage in accordance with one or more embodiments. Core index 411 represents a log associated with the time period T0 to T1. Core index 412 represents a log associated with the time period T1 to T2. Core index 413 represents a log associated with the time period T2 to T3. Core index 414 represents a log associated with the time period T3 to T4. Core index 415 represents a log associated with the time period T4 to T5. Core index 416 represents a log associated with the time period T5 to T6. FIG. 4A indicates the core indexes 411, 412, 413, 414, and 415 have been selected for reindexing. Core index 416 has not been selected for reindexing.

FIG. 4B illustrates an example set of the core indexes from FIG. 4A at the reindexing stage in accordance with one or more embodiments. A replacement core index is created for each of the selected core indexes. Core indexes 411, 412, 413, 414, and 415 have replacement core indexes 421, 422, 423, 424, and 425, respectively. In addition, a composite core index 430 is created for the purpose of collecting data that would otherwise be written to one of the core indexes being reindexed. Since each of the core indexes being reindexed are in a soft-closed state during the reindexing operation, data cannot be written to core indexes 411, 412, 413, 414, and 415. Instead, data that would otherwise be written to core indexes 411, 412, 413, 414, and 415 is written to core index 430 during the reindexing process. Meanwhile, each of core indexes 411, 412, 413, 414, and 415 are reindexed according to a reindexing plan, with the reindexed data being stored as replacement core indexes 421, 422, 423, 424, and 425.

FIG. 4C illustrates an example set of core indexes after the reindexing stage in accordance with one or more embodiments. Once the reindexing operations are complete, replacement core indexes 421, 422, 423, 424, and 425 replace core indexes 411, 412, 413, 414, and 415, respectively. In addition to the replacement core indexes, core index 416 and core index 430 remain after the reindexing operations are complete.

### 5. Practical Applications, Advantages & Improvements

In an embodiment, rebuilding the index can be challenging due to the potential for data availability issues during the reindexing process. The need to process the entire dataset can result in downtime or reduced functionality for the systems relying on the index, particularly in environments where the index is large, or the reindexing process is resource intensive. Maintaining a parallel index during the rebuild, and switching over to the new index upon completion, can require significant additional storage and computational resources. In situations where the original data source is unavailable or incomplete, rebuilding the index may also result in the loss of data that exists only in the current index. An embodiment addresses these challenges by processing a subset of the index data available for indexing, avoiding the need for full reindexing operations. By identifying and updating the portions of the index impacted by changes in the dataset, the system minimizes disruption to data availability.

In an embodiment, the time and resources required for a full index rebuild can also pose difficulties, especially in environments with large-scale datasets or limited computational capacity. Rebuilding an index involves reading data from the source, transforming it based on schema definitions, and writing the transformed data into the new index. This process can place significant demands on CPU, memory, and storage resources, potentially impacting other operations in the environment. The duration of the process may also be a concern, for longer reindexing times can delay the availability of the updated index and the implementation of schema or configuration changes. An embodiment addresses these difficulties by generating and executing a reindexing plan that accounts for resource constraints and/or other resource-related information, to help ensure efficient use of resources and system uptime. Avoiding or deprioritizing cores that are associated with indexes that would benefit less from reindexing operations helps reduce the computing resources associated with reindexing, thus reducing the impact of reindexing on overall performance of the system.

In an embodiment, rebuilding indexes in a multi-tenant search engine environment that may include sub-tenants introduces additional complexities related to maintaining tenant and sub-tenant isolation during reindexing. Tenants in the system may have distinct cores with indexes, schema definitions, and configurations tailored to specific datasets. Sub-tenants may have distinctly different cores, may inherit portions of these configurations, or may introduce customizations specific to their requirements. During reindexing, isolation mechanisms, such as tenant and sub-tenant identifiers, ensure that documents, configurations, and indexes associated with one tenant or sub-tenant remain inaccessible to others. These identifiers are consistently applied by the system during reindexing to maintain strict data separation across various levels of the hierarchy.

In an embodiment, resource contention in multi-tenant environments may create difficulties during reindexing, particularly when tenants and sub-tenants share infrastructure, such as indexing clusters, storage volumes, or computational nodes. Reindexing operations may consume excessive amounts of CPU, memory, and I/O bandwidth, potentially interfering with the performance of active queries or incremental indexing tasks for other tenants and sub-tenants. For example, if a parent tenant initiates a complete reindex operation, sub-tenants that share resources with the parent tenant may experience increased latency or resource exhaustion. The system balances reindexing demands with the operational needs of other tenants and sub-tenants. For example, the system generates a reindexing plan that takes into consideration the resource constraint information, expected resource usage, tenancy separation, and other resource-related information. When the system executes this plan, it monitors the resource-related information to ensure that the state of the resources associated with each tenant are consistent with thresholds set in the reindexing plan.

In an embodiment, schema updates in a multi-tenant search system can trigger cascading reindexing requirements across parent-tenant and sub-tenant hierarchies. Schema modifications, such as altering field types, adding new fields, or updating tokenization rules, often propagate from parent tenants to sub-tenants that inherit portions of the parent schema. Reindexing in this context requires ensuring that inherited schema changes are applied uniformly across sub-tenants while respecting any customizations that individual sub-tenants have introduced. Complexities increase when schema updates involve incompatible changes, as reindexing handles potential conflicts between the inherited schema and sub-tenant-specific configurations.

An embodiment addresses these complexities by introducing a structured process for managing reindexing tasks across a multi-tenant hierarchy. The system detects schema changes at the parent-tenant level, and then generates a dependency graph of impacted tenants to identify the cascade of sub-tenants requiring reindexing. The system then applies inherited schema updates to sub-tenants in a hierarchical manner. If a sub-tenant has schema elements that conflict with the inherited changes, the system either overrides the inherited schema based on pre-defined rules or flags the conflict for manual resolution. Reindexing is performed incrementally in accordance with a reindexing plan.

Tenants and sub-tenants may operate with distinct peak usage times, requiring careful coordination to minimize the impact of reindexing on active operations. Dependencies between parent and sub-tenant indexes may require reindexing to follow a specific sequence, where the parent tenant's updates are completed before sub-tenant reindexing begins. Staggered reindexing workflows can further help distribute the load on shared resources while maintaining consistent availability for query operations across the entire system.

In an embodiment, error handling and recovery in a multi-tenant search environment with sub-tenants require robust mechanisms to isolate and manage failures. Failures during reindexing for a parent tenant can cascade to sub-tenants that depend on the parent's data or schema, potentially leading to inconsistencies or downtime. Similarly, errors at the sub-tenant level can disrupt query or indexing operations specific to that sub-tenant without necessarily affecting others. Recovery processes support partial retries or rollbacks targeted at specific indexes or tenants, ensuring that the hierarchical integrity of the system is preserved by the system. Logging and monitoring systems designed for multi-level visibility help with identifying, diagnosing, and resolving issues during reindexing operations in such environments.

In an embodiment, incremental or partial updates to indexes may not adequately address schema changes or index format modifications. For example, when adding new fields or altering existing field types, the previously indexed data may not conform to the new schema definitions, resulting in incomplete or inconsistent query results. Rebuilding the index allows for the application of schema changes across the entire dataset, ensuring that indexed documents are processed by the system uniformly. Similarly, when major software upgrades introduce new index formats or storage optimizations, rebuilding the index ensures compatibility and takes full advantage of the improved capabilities provided by the upgrade.

One or more embodiments rebuild the index from scratch, helping to ensure a complete and accurate alignment between the index and the underlying data, schema definitions, and/or system configurations. Reindexing from scratch reprocesses the entire dataset, applying the current schema, analyzers, and tokenization rules to construct a fresh index. Rebuilding the index from scratch reduces or eliminates inconsistencies or legacy artifacts that might exist in the previous index, particularly after significant schema changes or software upgrades. By reconstructing the index entirely, this approach helps ensure that the new index is free from issues such as corruption, fragmentation, or compatibility mismatches.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread). A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

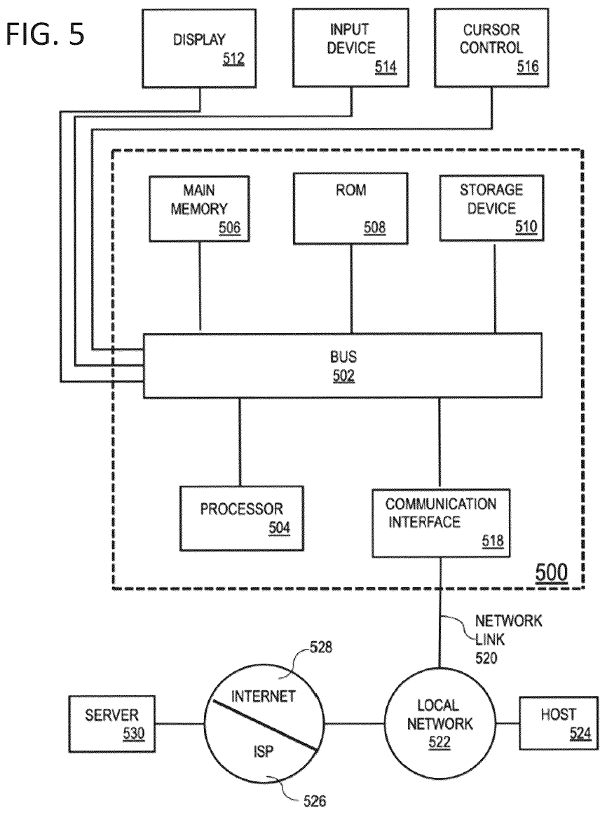

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid-State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
determining that a first core of a plurality of cores is associated with a first core index that is a candidate for reindexing,
wherein the first core is configured to execute a first running instance of the first core index, and
wherein the first core index comprises a first mapping of terms to metadata;
responsive to determining that the first core index is a candidate for reindexing, performing a first reindexing operation at least by:
detecting a first set of workload characteristics associated with the first core index,
based at least in part on the first set of workload characteristics, selecting a first configuration for the first reindexing operation, and
initiating the first reindexing operation using the first configuration;
wherein the method is performed by at least one device including a hardware processor.

2. The method of claim 1,
wherein determining that the first core is associated with a first core index that is a candidate for reindexing comprises determining that a first version associated with the first core index is an out-of-date version; and
wherein the first reindexing operation further comprises generating a reindexed version of the first index that is associated with a second version that is more recent than the first version.

3. The method of claim 2, wherein the first reindexing operation further comprises generating a replacement core comprising the reindexed version of the first index, and wherein the operations further comprise replacing the first core with the replacement core.

4. The method of claim 1, wherein determining that the first core is associated with a first core index that is a candidate for reindexing comprises detecting a change in a schema associated with the first core.

5. The method of claim 1, further comprising:
determining that a second core of the plurality of cores is associated with a second core index that is a candidate for reindexing;
wherein the second core is configured to execute a second running instance of the second core index, and
wherein the second core index comprises a second mapping of terms to metadata;
responsive to determining that the second core index is a candidate for reindexing, performing a second reindexing operation at least by:
detecting a second set of workload characteristics associated with the second core index,
based at least in part on the second set of workload characteristics, selecting a second configuration for the second reindexing operation,
initiating the second reindexing operation using the second configuration, and
wherein the first reindexing operation and the second reindexing operation are executed in parallel.

6. The method of claim 5, further comprising:
prior to the performance of the first reindexing operation and the second reindexing operation: placing the first core index and the second core index in a soft-closed state, wherein the soft-closed state is a state in which data may be read from the first core index and the second core index, and wherein data cannot be written to the first core index and the second core index.

7. The method of claim 6, further comprising:
identifying a set of one or more first attributes associated with the first core index, wherein incoming index data having one or more attributes matching one or more of the first attributes is written to the first core index;
identifying a set of one or more second attributes associated with the second core index, wherein incoming index data having one or more attributes matching one or more of the second attributes is written to the second core index;
creating a third core index;
executing a configuration change to cause incoming index data having one or more attributes matching one or more of the first attributes to be written to the third core index; and
wherein the configuration change further causes incoming index data having one or more attributes matching one or more of the second attributes to be written to the third core index.

8. The method of claim 6, wherein:
the first core index is associated with a first time period;
the second core index is associated with a second time period; and
the third core index is associated with both the first time period and the second time period.

9. The method of claim 6, further comprising:
performing a planning operation prior to the execution of the first reindexing operation, wherein the planning operation comprises:
determining that a third core of the plurality of cores is associated with a third core index that is a candidate for reindexing;
wherein the third core is configured to execute a third running instance of the third core index, and
wherein the third core index comprises a third mapping of terms to metadata;
predicting one or more expected resource use metrics, wherein each of the expected resource use metrics indicate the predicted resource usage for a corresponding resource;
based at least in part on the one or more expected resource use metrics, generating a first reindexing plan configured to maintain actual resource usage within a threshold amount of a configured parameter associated with the corresponding resource; and
wherein the first reindexing plan indicates that the first reindexing operation for the first core index and a second reindexing operation for the second core index should be performed during a first reindexing stage.

10. The method of claim 9, wherein the first reindexing plan further indicates that a third reindexing operation for the third core index should be performed during a second reindexing stage.

11. The method of claim 10, wherein the first core index, the second core index, and the third core index are associated with a first tenant in a cloud computing environment, and wherein the method further comprises:
determining that a fourth core of a second plurality of cores is associated with a fourth core index that is a candidate for reindexing;
wherein the fourth core is configured to execute a fourth running instance of the fourth core index;
wherein the fourth core index comprises a fourth mapping of terms to metadata;
wherein the fourth core index is associated with a second tenant in the cloud computing environment; and
responsive to determining that the fourth core index is a candidate for reindexing, performing a fourth reindexing operation.

12. The method of claim 11, wherein the first reindexing plan further indicates that the fourth reindexing operation for the fourth core index should be performed during the first reindexing stage.

13. The method of claim 11, further comprising:
generating a second reindexing plan that indicates that the fourth reindexing operation for the fourth core index should be performed during a third reindexing stage.

14. The method of claim 13, wherein the first reindexing plan is associated with the first tenant and the second reindexing plan is associated with the second tenant, and the method further comprises:
concurrently executing each reindexing operation associated with the first stage;
responsive to detecting that execution of each reindexing operation associated with the first stage has completed, concurrently executing each reindexing operation associated with the second stage;
concurrently executing each reindexing operation associated with the third stage; and
responsive to detecting that execution of each reindexing operation associated with the third stage has completed, concurrently executing each reindexing operation associated with a fourth stage, wherein the fourth stage is associated with the second reindexing plan.

15. The method of claim 14, wherein the reindexing operations associated with the first reindexing plan are performed independently from the reindexing operations associated with the second reindexing plan.

16. The method of claim 4, wherein the operations further comprise performing a planning operation prior to the execution of the first reindexing operation, wherein the planning operation comprises:
determining that a third core of the plurality of cores is associated with a third core index that is a candidate for reindexing;
determining that a fourth core of the plurality of cores is associated with a third core index that is a candidate for reindexing;
wherein the first core and the second core are associated with a first tenant;
wherein the third core and the fourth core are associated with a second tenant;
wherein the first core index is one of a first plurality of core indexes associated with a first sub-tenant;
wherein the second core index is one of a second plurality of core indexes associated with a second sub-tenant;
wherein the third core index is one of a third plurality of core indexes associated with a third sub-tenant;
wherein the fourth core index is one of a fourth plurality of core indexes associated with a fourth sub-tenant;
predicting one or more expected resource use metrics associated with the first, second, third, and fourth sub-tenants, wherein each of the expected resource use metrics indicate the predicted resource usage for a corresponding resource; and
based at least in part on the one or more expected resource use metrics, generating a first reindexing plan that is configured to maintain actual resource usage within a threshold amount of a configured parameter associated with the corresponding resource.

17. The method of claim 16, wherein the first reindexing plan indicates that the first reindexing operation for the first core index and a second reindexing operation for the second core index should be performed independently from one another.

18. The method of claim 16, wherein the first reindexing plan is associated with the first plurality of core indexes, and the method further comprises:
generating a second reindexing plan associated with the second plurality of core indexes;
generating a third reindexing plan associated with the third plurality of core indexes; and
generating a fourth reindexing plan associated with the fourth plurality of core indexes.

19. One or more non-transitory computer readable media comprising instructions which, when executed by one or more hardware processors, cause performance of operations comprising:
determining that a first core of a plurality of cores is associated with a first core index that is a candidate for reindexing,
wherein the first core is configured to execute a first running instance of the first core index, and
wherein the first core index comprises a first mapping of terms to metadata;
responsive to determining that the first core index is a candidate for reindexing, performing a first reindexing operation at least by:
detecting a first set of workload characteristics associated with the first core index;
based at least in part on the first set of workload characteristics, selecting a first configuration for the first reindexing operation; and
initiating the first reindexing operation using the first configuration.

20. A system comprising:
at least one device including a hardware processor;
the system being configured to perform operations comprising:
determining that a first core of a plurality of cores is associated with a first core index that is a candidate for reindexing,
wherein the first core is configured to execute a first running instance of the first core index, and
wherein the first core index comprises a first mapping of terms to metadata;
responsive to determining that the first core index is a candidate for reindexing, performing a first reindexing operation at least by:
detecting a first set of workload characteristics associated with the first core index;
based at least in part on the first set of workload characteristics, selecting a first configuration for the first reindexing operation; and
initiating the first reindexing operation using the first configuration.
